(19) United States
(12) Patent Application Publication
(10) Pub. No.: US 2003/0081116 A1
(43) Pub. Date: May 1, 2003

(54) Door mirror viewer

(76) Inventor: Khosrow Bahrayni-Moghaddam, Weston (CA)

Correspondence Address: KHOSROW BAHRAYNI-MOGHADDAM, 36 ARKLEY CRESCENT, WESTON, ON, M9R 353, CA

(21) Appl. No.: 10/042,432

(22) Filed: Jan. 10, 2002

(30) Foreign Application Priority Data
Oct. 30, 2001 (CA) 2,360,512

(51) Int. Cl. H04N 7/18

(52) U.S. Cl. 348/61

(57) ABSTRACT

In this invention, we will install two parts: the first part, (same as door viewer) with lens; the second part is the mirror which connected to the lens. Anyone who comes to the door, we don't need to peek on that little hole. The picture of the person outside the door is automatically show on the electronic mirror which is installed to the inside door.

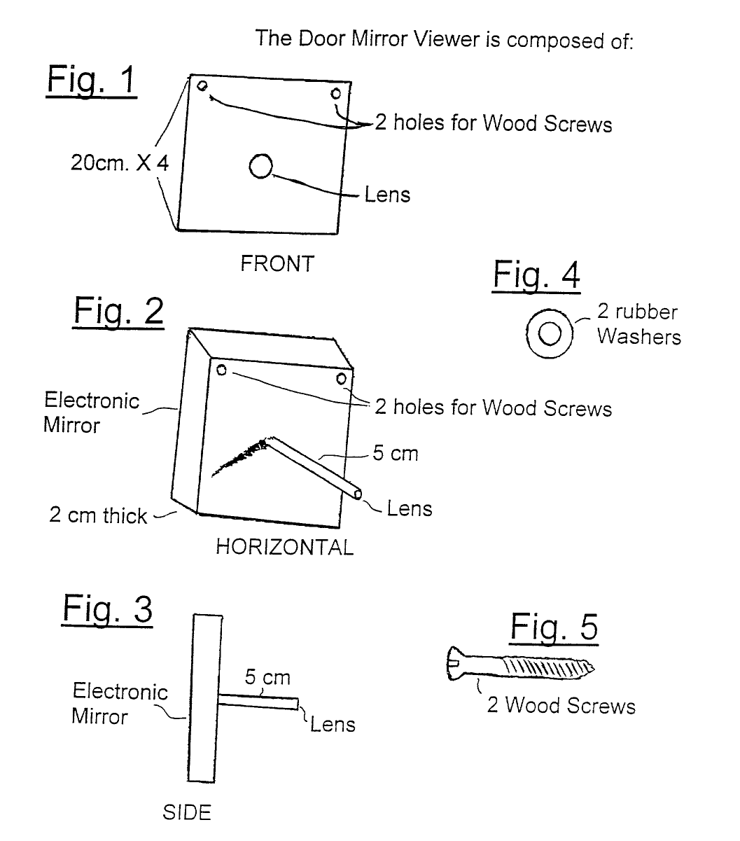

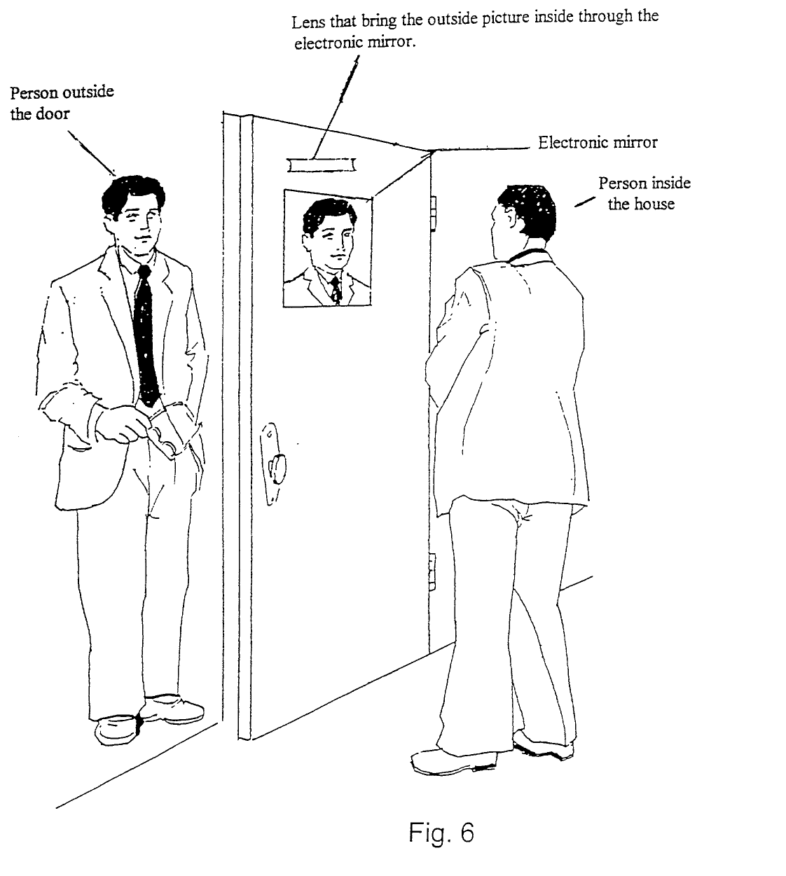

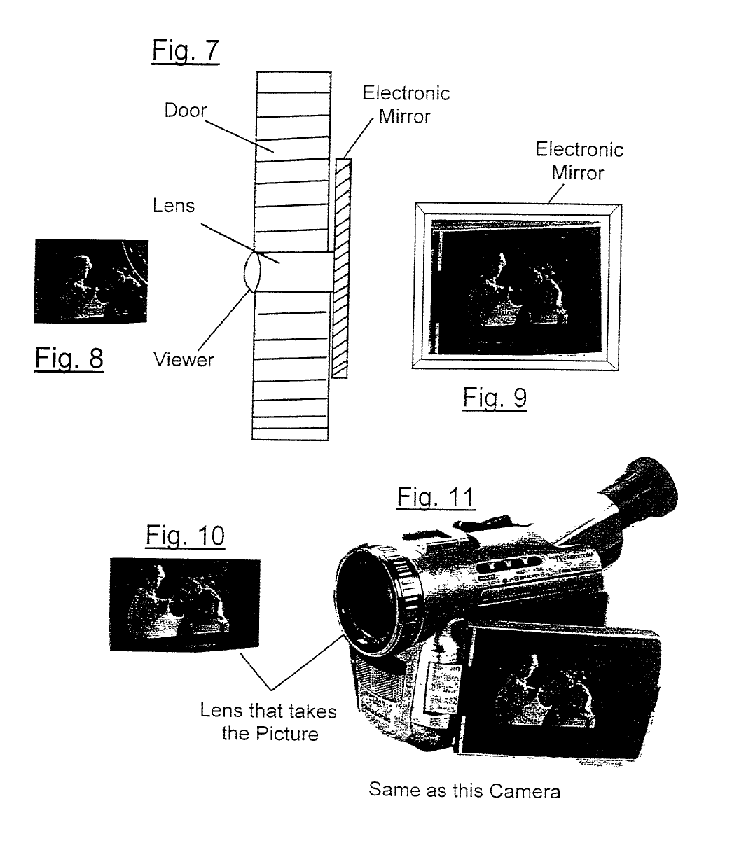

This invention is called THE DOOR MIRROR VIEWER. The difference between the DOOR VIEWER to THE DOOR MIRROR VIEWER, the Door Viewer, you need to go to the door and peek on to the hole to see who were at the door, not everybody in the house can do that, especially the children, not only it's too high for them to reach and peek, they cannot easily recognize the person outside. So sometimes they end up opening the door anyway. It's not safe.

THE DOOR MIRROR VIEWER is safer and easier to anyone who lives in an apartment or in a house. The mirror size is about 20×20 cm. The electronic mirror works with battery which is connected to the LENS, easy to insulate to the door. We can see anyone who comes to the door approximately 2 meters before they reach the door. So we have time to call for help if it is an intruder or simply don't want to entertain anyone in your precious time, pretend you're not home.

It's more easier and safer for the children to recognize instantly the person outside their door. So they know when to open the door or not to open at all for their safety, these days all kinds of criminals are everywhere.

We claim:

1. The embodiment of this invention, the combination of electronic is claimed as follows:
The equipments, the MIRROR and the LENS are attach together, we will make a hole in the middle of the door of about 2½ cm. We insulate the lens inside the door that shows also outside the door, that lens will take the picture to whoever is outside that door.
We have a two hole on both side of the top of the mirror. With the use of two wood screw and rubber washer to hold secure the mirror on the door.
